(19) United States
(12) Patent Application Publication
(10) Pub. No.: US 2007/0140931 A1
(43) Pub. Date: Jun. 21, 2007

(54) Air current generator

(75) Inventors: GuoSheng Huang, PingTan Town (CN); ZhiXiang Su, BeiJiao Town (CN)

Correspondence Address: Raymond Y. Chan, #128, 108 N. Ynez Ave., Monterey Park, CA, 91754, US

(73) Assignee: ZhiXiang SU

(21) Appl. No.: 11/336,299

(22) Filed: Jan. 19, 2006

(30) Foreign Application Priority Data
Dec. 20, 2005 (CN) 200510121061.4

(51) Int. Cl. B01J 19/08

(52) U.S. Cl. 422/186.04

(57) ABSTRACT

An air current generator includes an outer casing, a power unit, an air temperature control device, and an ionizing airflow generator. The air temperature control device is electrically connected to the power unit for generating a temperature-controlled air within the air ventilating cavity of the outer casing. The ionizing airflow generator includes an ionizing airflow unit which includes a first electrode set as an electrode terminal disposed within the outer casing at a position close to an air inlet, and a second electrode set disposed within the outer casing at an air outlet, wherein a voltage of the second electrode set is higher than a voltage of the first electrode set to generate an electrostatic force for drawing a flow of air from the air inlet to the air outlet so as to guide the temperature-controlled air within the outer casing to the exterior of the outer casing through the air outlet.

### BACKGROUND OF THE PRESENT INVENTION

1. Field of Invention

The present invention relates to an air delivering device, and more particularly to an air current generator which comprises an ionizing airflow generator for producing air flow so as to deliver cool or heated air to an exterior of the air current generator.

2. Description of Related Arts

A conventional air ventilating device, such as a conventional air conditioning device, usually comprises an outer casing having an air inlet and an air outlet, a heat exchanging system provided in the outer casing, and an airflow generator mounted within the outer casing to operatively communicate with the heat exchanging system, in such a manner that the airflow generator is adapted to actively draw air from ambient environment to the heat exchanging system via the air inlet, and then deliver air from the heat exchanging system back to the ambient environment via the air outlet. When the air passes through the heat exchanging system, a predetermined amount of heat is extracted from or transferred to a heat reservoir so as to alter the temperature of the air flowing through the heat exchanging system.

A typical airflow generator is usually embodied as an axial fan rotatably mounted within the outer casing and aligned with the air inlet, so that the axial fan is arranged to rotate for drawing air from the ambient environment to pass through the heat exchanging system and then discharged through the air outlet with predetermined a flow rate.

There are several disadvantages with this kind of convention airflow generator. First and foremost, the airflow generator, such as the axial fan, is responsible for generating a high level of noise so as to severely undermine the range of applications of the entire air ventilating device. For example, too noisy an air conditioning system is not suitable for domestic use because the noise may affect family members to have a good sleep.

Secondly, since the airflow generator is operated by rotation of a plurality of fan blades, there is significant energy loss when electrical energy is transformed to mechanical energy. There are several reasons for such energy loss, the most well known being the frictional loss at the driving hub from which the fan blades are outwardly extending.

Thirdly, when the airflow generator is utilized as the air ventilating device itself, such as where the air ventilating device is embodied as an electric fan without the heat exchanging system, the structure of the entire ventilating device must be specifically designed to cater for the rotating fan blades. For example, the air ventilating device must comprise a protective cover to avoid the fan blades from being accidentally touched by its users, particularly children. As a result, there is little flexibility in terms of its use and design.

Finally, it is important to note that the above-mentioned disadvantages also apply to a conventional heating system.

### SUMMARY OF THE PRESENT INVENTION

A main object of the present invention is to provide an air current generator which comprises an ionizing airflow generator adapted for producing airflow to deliver air to an exterior of the air current generator without using fan blades.

Another object of the present invention is to provide an air current generator which may be embodied as a wide range of air delivering or purifying devices so as to facilitate a wide range of applications of the present invention.

Another object of the present invention is to provide an air current generator which is capable of generating airflow having a flow rate comparable with most conventional air ventilating device, so that the present invention can be utilized in lieu of conventional air ventilating devices, with the advantages of enhanced flexibility in structural design and having a wider range of applications.

Another object of the present invention is to provide an air current generator which is capable of creating airflow for air conditioning purpose without simultaneously generating significant noise.

Another object of the present invention is to provide an air current generator which does not involve complicated mechanical or electrical components so as to minimize the manufacturing cost as well as the ultimate selling price of the present invention.

Accordingly, in order to accomplish the above objects, the present invention provides an air current generator, comprising:

an outer casing having an air ventilating cavity, an air inlet and an air outlet communicating the air ventilating cavity with an exterior of the outer casing;

a power unit supported within the outer casing;

an air temperature control device electrically connect to the power unit for generating a temperature controlled air within the air ventilating cavity of the outer casing; and

an ionizing airflow generator, which is electrically connected to the power unit, comprising:

an ionizing airflow unit, which is electrically connected to the power unit, comprising a first electrode set as an electrode terminal disposed within the outer casing at a position close to the air inlet, and a second electrode set disposed within the outer casing at the air outlet, wherein a voltage of the second electrode set is higher than a voltage of the first electrode set to generate an electrostatic force for drawing a flow of air from the air inlet to the air outlet so as to guide the temperature-controlled air within the outer casing to the exterior of the outer casing through the air outlet.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of an air current generator according to a preferred embodiment of the present invention.

FIG. 2 is a schematic diagram of the air temperature control device according to the above preferred embodiment of the present invention.

FIG. 3A and FIG. 3B are schematic diagrams of the ionizing airflow generator according to the above preferred embodiment of the present invention.

FIG. 4A and FIG. 4B are the first schematic diagrams of the first alternative mode of the air current generator according to the above preferred embodiment of the present invention, illustrating the electrode sets of the ionizing airflow generator.

FIG. 5A and FIG. 5B are the second schematic diagrams of the first alternative mode of the air current generator according to the above preferred embodiment of the present invention, illustrating the electrode sets of the ionizing airflow generator.

FIG. 6A and FIG. 6B are the first schematic diagrams of the second alternative mode of the air current generator according to the above preferred embodiment of the present invention, illustrating the electrode sets of the ionizing airflow generator.

FIG. 7A and FIG. 7B are the second schematic diagrams of the second alternative mode of the air current generator according to the above preferred embodiment of the present invention, illustrating the electrode sets of the ionizing airflow generator.

FIG. 8A and FIG. 8B are third alternative mode of the air current generator according to the above preferred embodiment of the present invention, illustrating the electrode sets of the ionizing airflow generator.

FIG. 9A and FIG. 9B are schematic diagrams of the electrode sets according to the above preferred embodiment of the present invention.

FIG. 10 illustrates that the air temperature control device may be used for ventilating air in a domestic environment.

### DETAILED DESCRIPTION OF THE PREFERRED EMBODIMENT

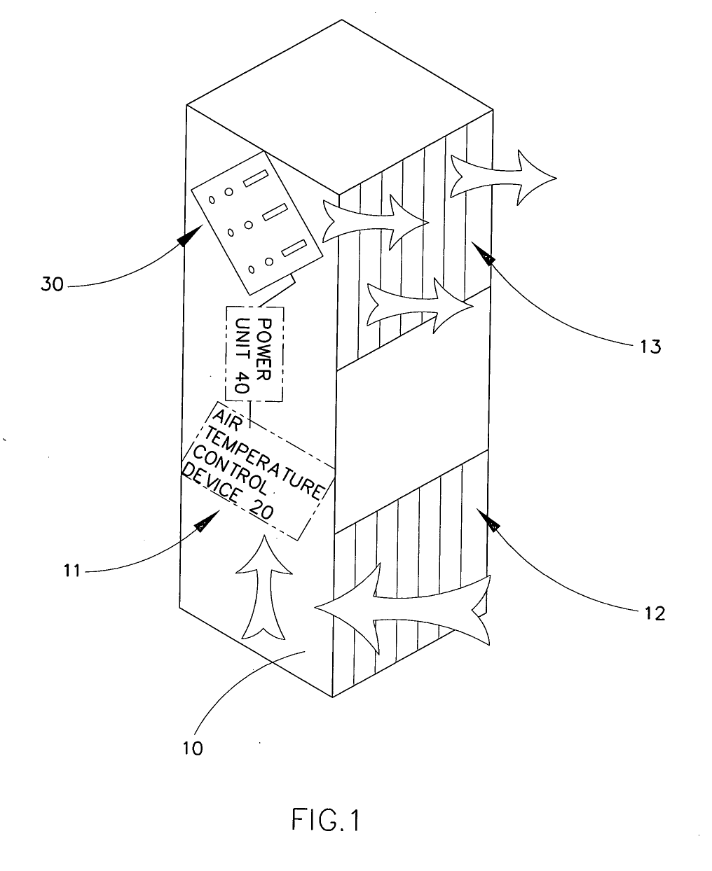

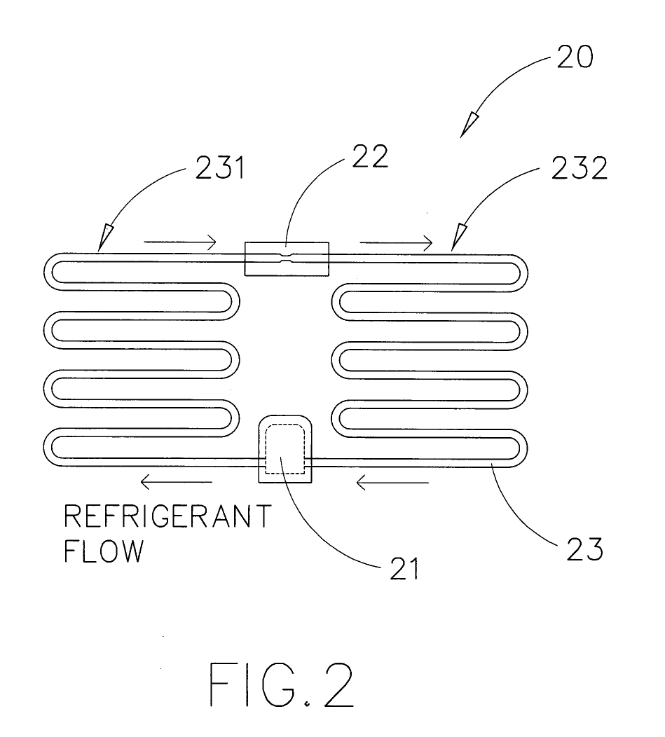

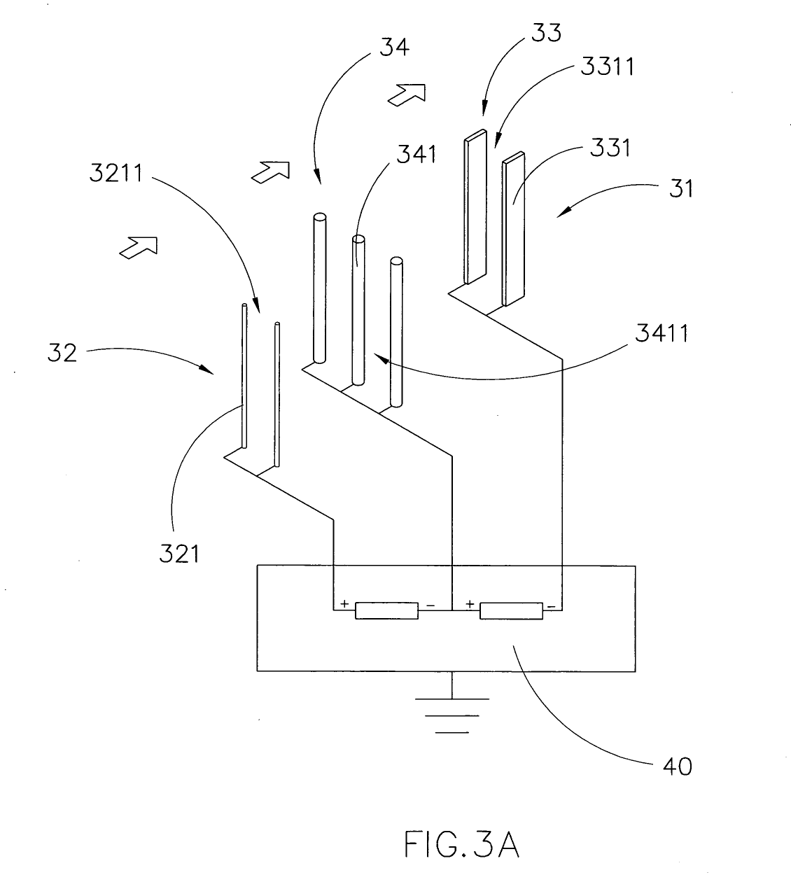

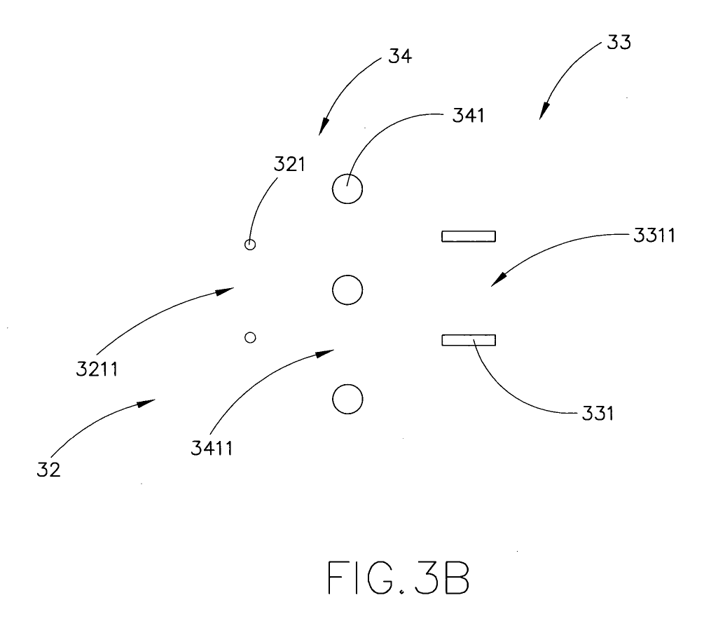

Referring to FIG. 1 to FIG. 2, FIG. 3A and FIG. 3B of the drawings, an air current generator according to a preferred embodiment of the present invention is illustrated, in which the air current generator comprises an outer casing 10, an air temperature control device 20, an ionizing airflow generator 30, and a power unit 40 supported within the outer casing 10.

The outer casing 10 has an air ventilating cavity 11, an air inlet 12 and an air outlet 13 communicating the air ventilating cavity 11 with an exterior of the outer casing 10.

The air temperature control device 20, such as an air cooling device, is electrically connected to the power unit 40 for generating a temperature-controlled air within the air ventilating cavity 11 of the outer casing 10.

The ionizing airflow generator 30 is electrically connected to the power unit 40, and comprises an ionizing airflow unit 31, which is electrically connected to the power unit 40, and comprises a first electrode set 32 as an electrode terminal disposed within the outer casing 10 at a position close to the air inlet 12, and a second electrode set 33 disposed within the outer casing 10 at the air outlet 13, wherein a voltage supplied to the second electrode set 33 is higher than a voltage supplied to the first electrode set 32 to generate an electrostatic force for drawing a flow of air from the air inlet 12 to the air outlet 13 so as to guide the temperature-controlled air within the outer casing 10 to the exterior of the outer casing 10 through the air outlet 13.

According to the preferred embodiment of the present invention, the air temperature control device 20 comprises a compressor 21, an expansion valve 22, and a heat exchanging tube 23 reciprocally extended between the compressor 21 and the expansion valve 22 to form a hot coil portion 231 and a cold coil portion 232 of the heat exchanging tube 23. The air cooling device further contains a predetermined amount of refrigerant circulating along the heat exchanging tube 23 via the compressor 21 and the expansion valve 22 for exchanging heat with the air drawn from the air inlet 12.

The operation of the air cooling device is as follows: the refrigerant is circulating along the heat exchanging tube 23. When the refrigerant passes the compressor 21, it is thermodynamically compressed to reach gaseous state at high temperature and high pressure, and is discharged to the hot coil portion 231 where the gaseous refrigerant is allowed to cool down for transforming into liquid state. The liquid refrigerant is then circulated to pass through the expansion valve 22 so that it is thermodynamically transformed into gaseous state having low temperature and low pressure. The gaseous refrigerant is then allowed to circulate through the cold coil portion 232 which is adapted to thermodynamically communicate with the air drawing from the air inlet 12 so as to absorb heat therefrom for lowering the temperature of the air from the air inlet 12 (by simple heat transfers mechanism). It is worth mentioning that the circulation of the refrigerant may be accomplished by a pump.

The ionizing airflow unit 31 further comprises a third electrode set 34 disposed within the outer casing 10 at a position between the first and second electrode set 32, 33, wherein a voltage supplied to the third electrode set 34 is higher than a voltage supplied to the first electrode set 32 for drawing the air from the first electrode set 32 to the third electrode set 34, and the voltage supplied to the third electrode set 34 is lower than a voltage supplied to the second electrode set 33 for accelerating the air from the third electrode set 34 to the second electrode set 33, such that when the ionizing airflow unit 31 is arranged for effectively drawing the air from the air inlet 12 to the air outlet 13 through the air ventilating cavity 11, the air will be thermally altered by the air temperature control device 20 while the temperature-controlled air is discharged via the air outlet 13 for supplying the temperature-controlled air to an exterior of the outer casing 10.

The power unit 40 is electrically connected with the first through third electrode set 32, 33, 34 to apply the predetermined potential differences between the first and the second electrode set 32, 33, and between the second and the third electrode set 33, 34 for ionizing air in within the air ventilating cavity so as to create the electrostatic force causing airflow between the air inlet 12 and the air outlet 13.

More specifically, the second electrode set 33 is spacedly provided from the first electrode set 32 while the third electrode set 34 is spacedly provided from the second electrode set 33 so as to produce ionizing effect between the first electrode set 32 and the third electrode set 34, and between the second electrode set 33 and the third electrode set 34.

Referring to FIG. 3A and FIG. 3B of the drawings, the first electrode set 32 comprises a plurality of first electrode elements 321 spacedly formed in an array to define a first air channel 3211 between each two first electrode elements 321, wherein the second electrode set 33 comprises a plurality of second electrode elements 331 spacedly formed in an array to define a second air channel 3311 between each the two second electrode elements 331, wherein the third electrode set 34 comprises a plurality of third electrode elements 341 spacedly formed in an array to define a third air channel 3411 between each the two third electrode elements 341, wherein the number of the first elements 321 is equal to the number of the second elements 331. According to the preferred embodiment of the present invention, at least one of the third electrode elements 341 is aligned with one of the first air channels 3211.

Each of the first electrode elements 321 is an electrode wire supported within the air ventilating cavity 11 at the air inlet 12, wherein each of the second electrode elements 331 is a second electrode blade supported within the air ventilating cavity 11 at the air outlet 13, wherein each of the third electrode elements 341 is a third electrode shaft, having an electrode surface smaller than an electrode surface of the second electrode blade, supported within the air ventilating cavity 11 at a position between the electrode wire and the second electrode blades.

In other words, the first electrode set 32 comprises a plurality of electrode wires spacedly mounted in an array within the air ventilating cavity 11, while the third electrode set 34 comprises a plurality of third electrode shafts spacedly mounted in array within the air ventilating cavity 11 and spacedly positioned away from the first electrode set 32. On the other hand, the second electrode set 33 comprises a plurality of second electrode blades spacedly mounted in array and spacedly positioned away from the third electrode set 34 in the vicinity of the air outlet 13 in such a manner that the high potential difference with respect to the third electrode set 34 is adapted to draw temperature-controlled air (which comes from the air temperature control device 20) in the vicinity of the third electrode set 34 flowing towards the second electrode set 33.

It is worth mentioning that the potential difference between the first electrode set 32 and the second electrode set 33, and between the second electrode set 33 and the third electrode set 34 have to be carefully selected in order to ensure optimal ionizing of the air within the air ventilating cavity 11. More specifically, the first through third electrode set 32, 33, 34 are electrically arranged in such a manner that the third electrode set 34 is negative with respect to the first electrode set 32, while the third electrode set 34 is positive with respect to the second electrode set 33.

According to the preferred embodiment of the present invention, the electrical level of the third electrode set 34 is doubled of that of the first electrode set 32 so as to constitute a predetermined potential difference between the first electrode set 32 and the third electrode set 34, wherein the electrical level of the second electrode set 33 is doubled of that of the third electrode set 34 so as to constitute a predetermined potential difference between the first electrode set 32 and the third electrode set 34, and between the third electrode set 34 and the second electrode set 33.

In other words, a potential difference between the first and second electrode sets 32, 33 is at least two times more than a potential difference between the first and third electrode sets 32, 34, such that the first and third electrode sets 32, 34 are adapted for drawing the air through the air inlet 12 while the third and second electrode sets 34, 33 are adapted for accelerating the air towards the air outlet 13.

According to the preferred embodiment of the present invention, the potential difference which can be supplied by the power unit 40 should be in the range of 5 kV to 70 kV, and a frequency in the range of 18 kHz and 120 kHz, wherein the power unit 40 is arranged to supply a voltage of 5 kV to 30 kV to the first electrode set 32, a voltage of 5 kV to 40 kV to the second electrode set 33, and a voltage of 10 kV to 30 kV to the third electrode set 34.

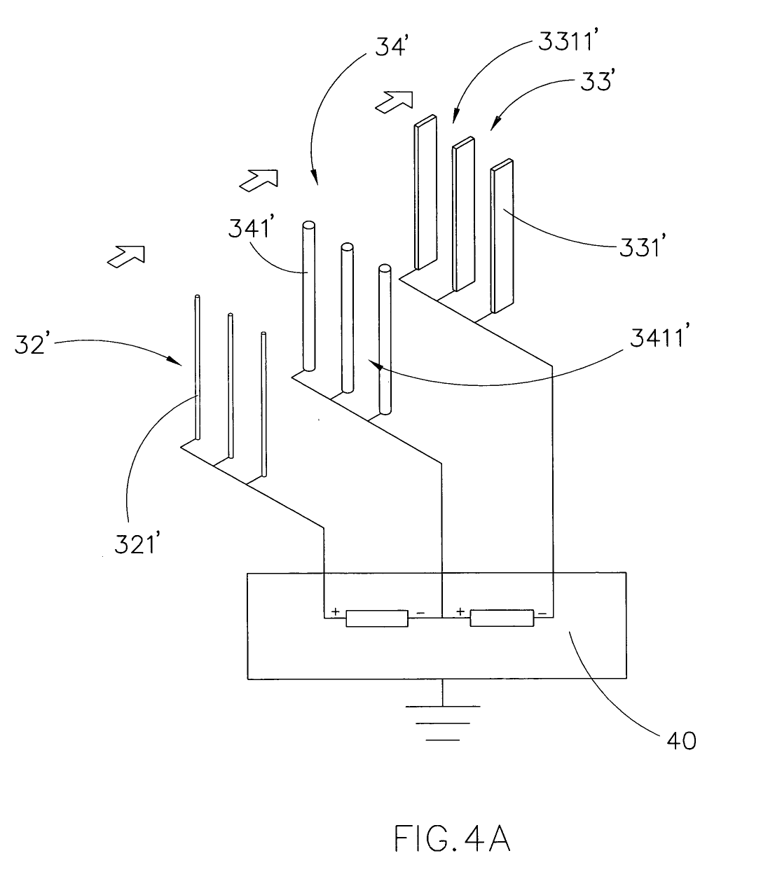

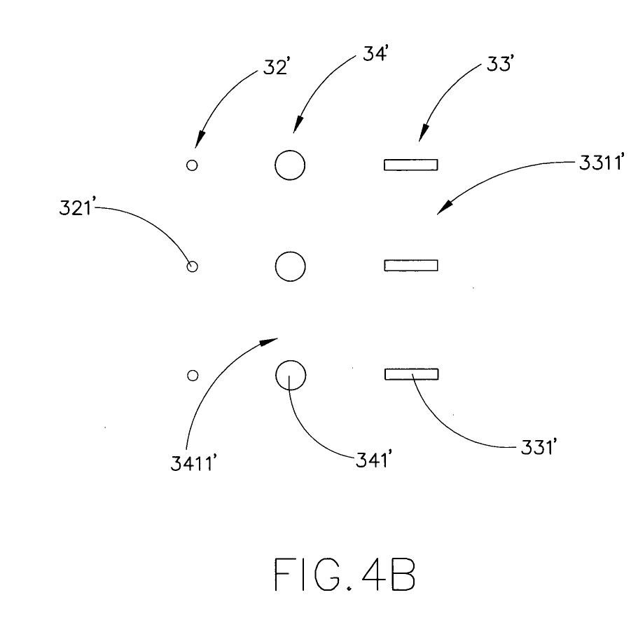

Referring to FIG. 4A and FIG. 4B of the drawings, a first alternative mode of the air current generator according to the above-mentioned preferred embodiment of the present invention is illustrated. The first alternative mode is similar to the preferred embodiment except the first through third electrode set 32′, 33′, 34′ of the ionizing airflow generator 30′. According to the first alternative mode, each of the first electrode elements 321′ is an electrode wire supported within the air ventilating cavity 11 at the air inlet 12, wherein each of the second electrode elements 331′ is an electrode blade supported within the air ventilating cavity 11 at the air outlet 13, wherein each of the third electrode elements 341′ is an electrode shaft, having an electrode surface smaller than an electrode surface of the second electrode blade, supported within the air ventilating cavity 11 at a position between the electrode wire and the electrode blade. A shown in FIG. 4A and FIG. 4B of the drawings, for each of the first through third electrode set 32′, 33′, 34′, there are three electrode elements 321′, (331′), (341′) aligning in array for generating the airflow, wherein at least one of the second air channels 3311′ is aligned with one of the third air channels 3411′ and one of the first air channels 3211′.

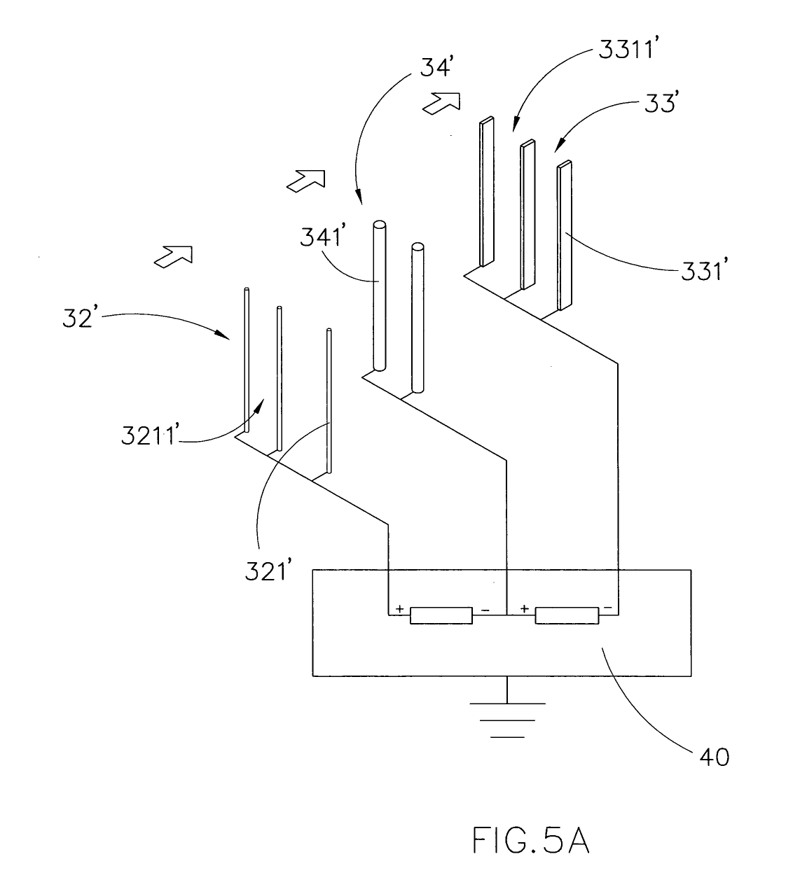

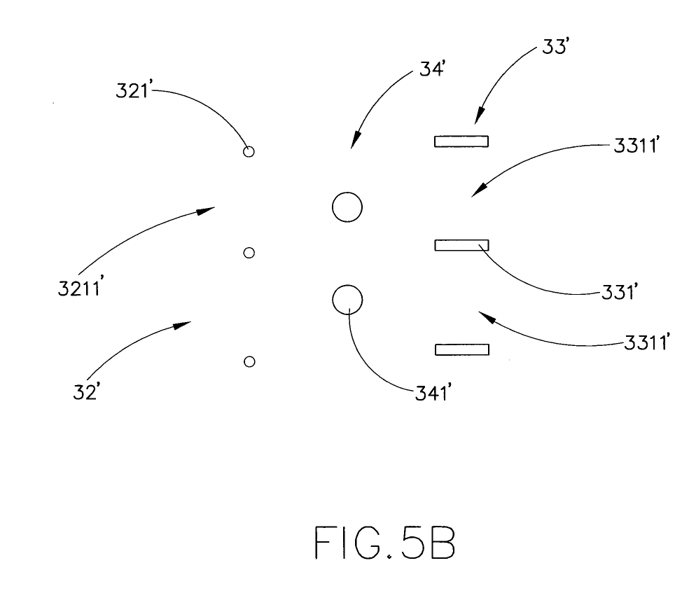

However, it is worth mentioning that there may be three first electrode elements 321′ for the first electrode set 32′, three second electrode elements 331′ for the second electrode set 32′, and two third electrode elements 341′ for the third electrode set 34′, wherein at least one of the second air channels 3311′ is aligned with one of the first electrode element 321′, as shown in FIG. 5A and FIG. 5B of the drawings.

In other words, the first electrode set 32′ comprises a plurality of electrode wires spacedly mounted in array within the air ventilating cavity 11, the second electrode set 33′ comprises a plurality of second electrode blades spacedly mounted in array in the vicinity of the air outlet 13 and is spacedly apart from the first electrode set 32′, while the third electrode set 34′ comprises a plurality of electrode shafts spacedly mounted in array within the air ventilating cavity 11 between the first and the second electrode set 32′, 33′, in such a manner that air is drawn from the first electrode set 32′ to the second electrode set 33′ via the third electrode set 34′ in the similar fashion as in the preferred embodiment.

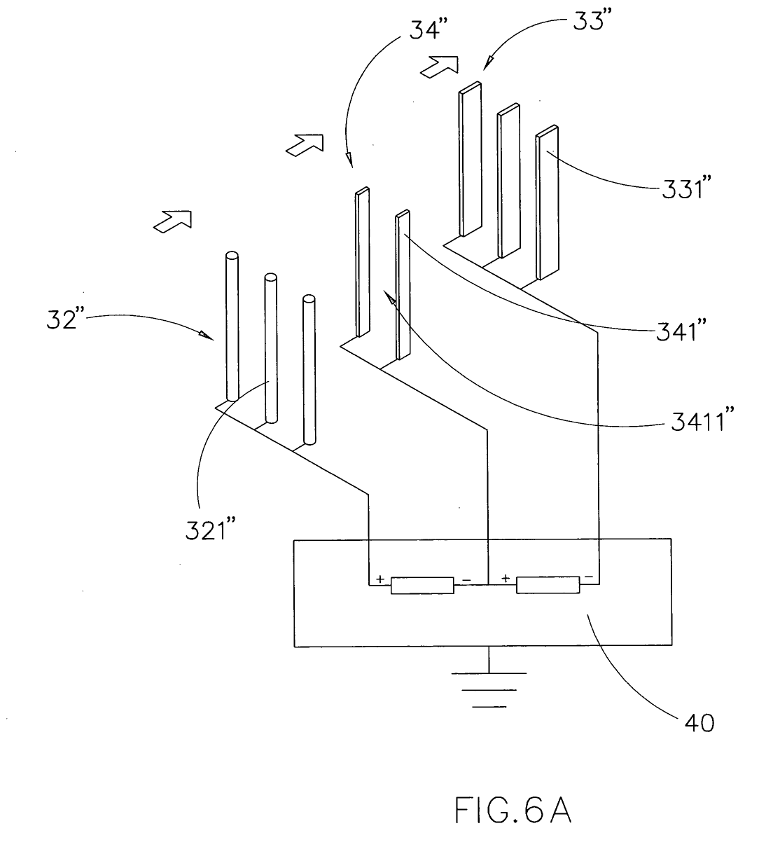

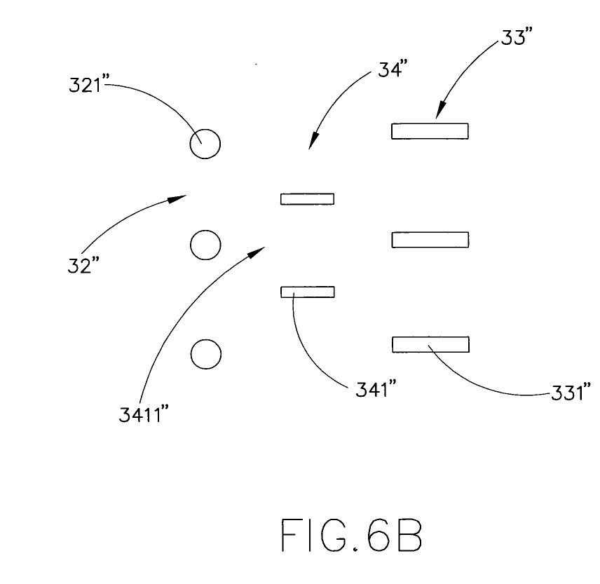

Referring to FIG. 6A and FIG. 6B of the drawings, a second alternative mode of the air current generator according to the above-mentioned preferred embodiment of the present invention is illustrated. The second alternative mode is similar to the preferred embodiment except the first through third electrode set 32″, 33″, 34″. According to the second alternative mode, each of the first electrode elements 321″ is an electrode shaft supported within the air ventilating cavity 11 at the air inlet 12, wherein each of the second electrode elements 331″ is a second electrode blade supported within the air ventilating cavity 11 at the air outlet 13, wherein each of the third electrode elements 34″ is a third electrode blade, having an electrode surface smaller than an electrode surface of the second electrode blade, supported within the air ventilating cavity 11 at a position between the electrode shaft and the second electrode blade. Moreover, at least one of the second electrode elements 331″ is aligned with one of the third air channels 3411″. As shown in FIG. 6A and FIG. 6B of the drawings, there are three first electrode elements 321″, three second electrode elements 331″ and two third electrode elements 341″ for the first through third electrode set 32″, 33″, 34″ respectively.

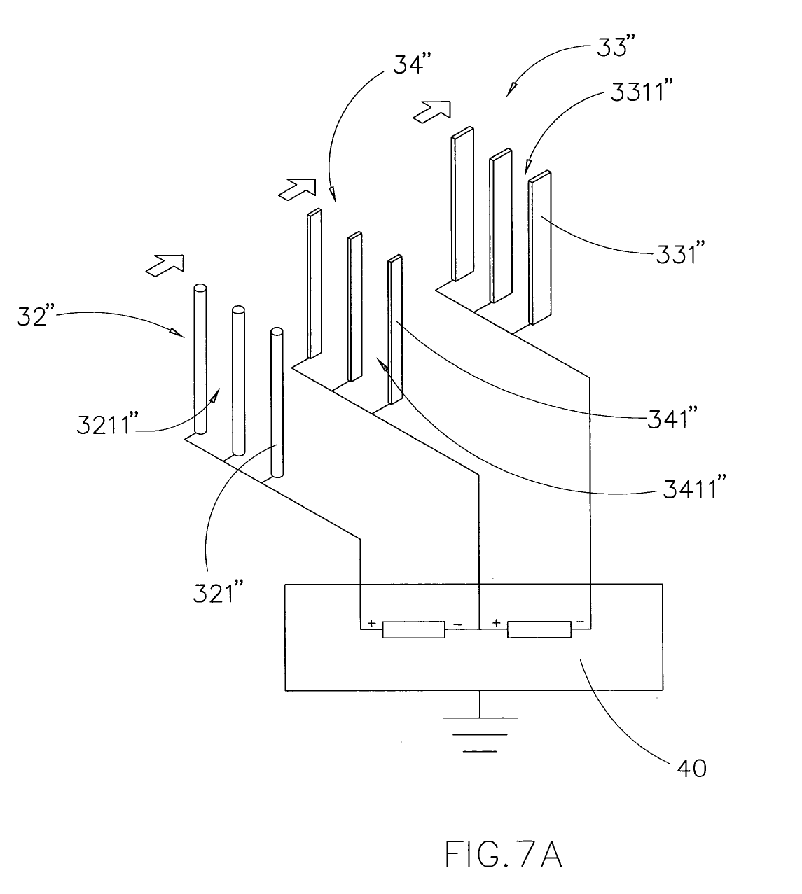

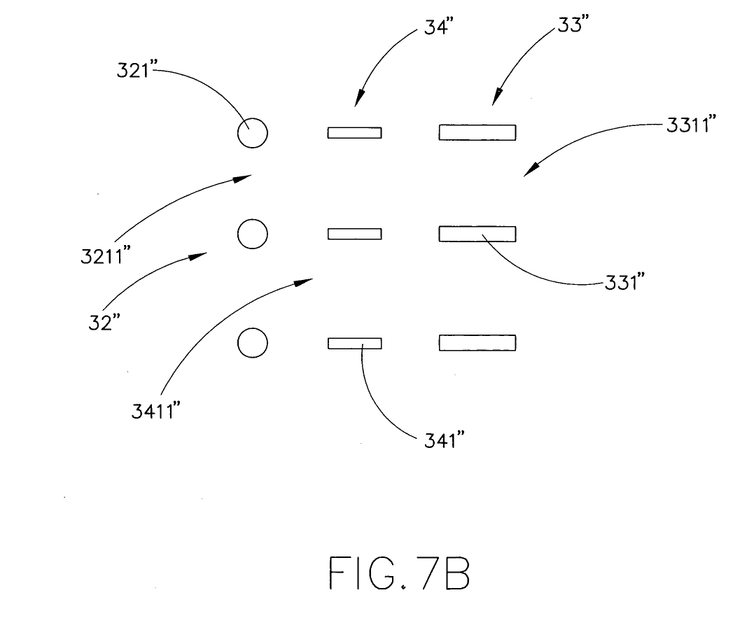

However, it is worth mentioning that there may be three first electrode elements 321″ for the first electrode set 32″, three second electrode elements 331″ for the second electrode set 32″, and three third electrode elements 341″ for the third electrode set 34″, wherein the second air channels 3311′ are aligned with the first air channel 3211″ and as well as the third air channels 3411″ respectively, as shown in FIG. 7A and FIG. 7B of the drawings.

In other words, the first electrode set 32″ comprises a plurality of electrode shafts spacedly mounted in array within the air ventilating cavity 11, the second electrode set 33″ comprises a plurality of second electrode blades spacedly mounted in array in the vicinity of the air outlet 13 spacedly apart from the first electrode set 32″, while the third electrode set 34″ comprises a plurality of third electrode blades spacedly mounted in array within the air ventilating cavity 11 between the first and the second electrode set 32″, 33″, in such a manner that air is drawn from the first electrode set 32″ to the second electrode set 33″ via the third electrode set 34″ in the similar fashion as in the preferred embodiment.

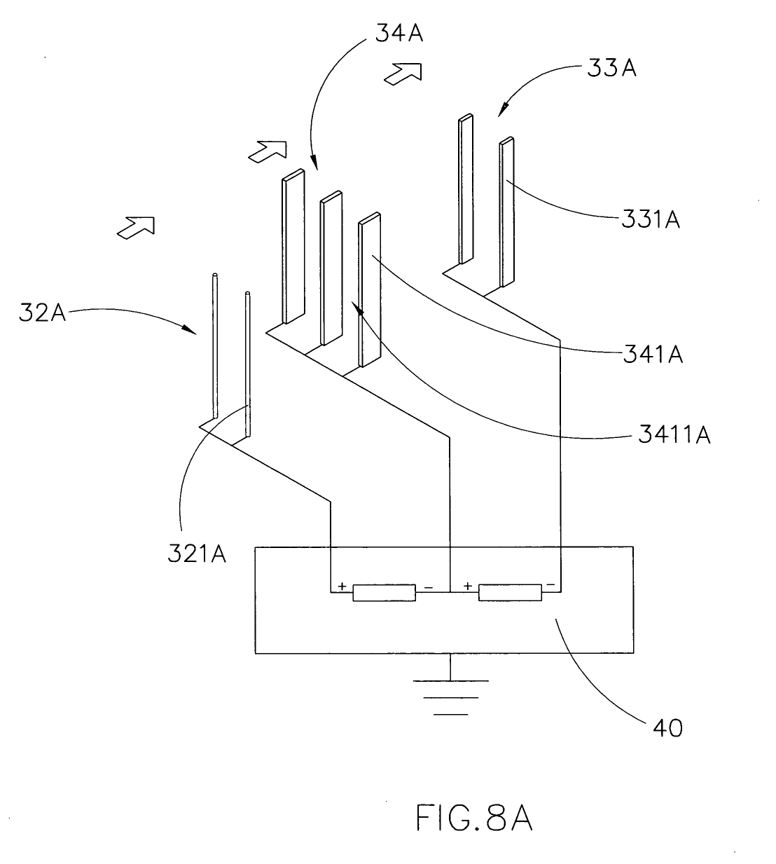

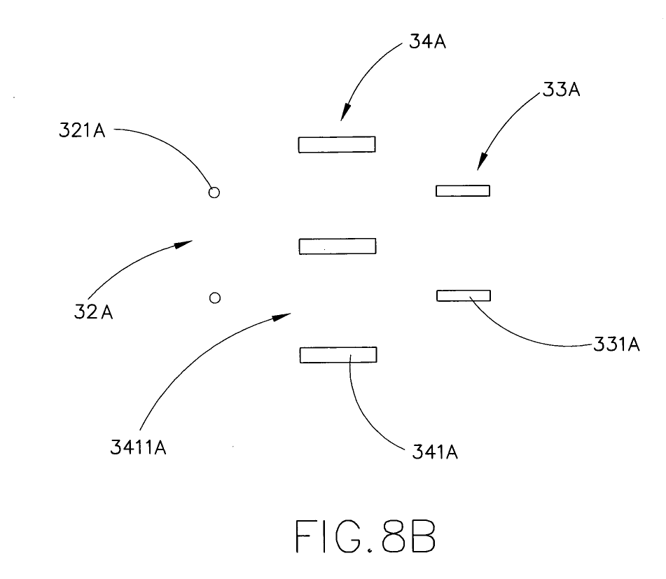

Referring to FIG. 8A and FIG. 8B of the drawings, a third alternative mode of the air purifier according to the above-mentioned preferred embodiment of the present invention is illustrated. The third alternative mode is similar to the preferred embodiment except the first through third electrode set 32A, 33A, 34A. According to the third alternative mode, each of the first electrode elements 321A is an electrode wire supported within the air ventilating cavity 11 at the air inlet 12, wherein each of the second electrode elements 331A is a second electrode blade supported within the air ventilating cavity 11 at the air outlet 13, wherein each of the third electrode elements 341A is a third electrode blade, having an electrode surface larger than an electrode surface of the second electrode blade, supported within the air ventilating cavity 11 at a position between the electrode wire and the second electrode blade. Moreover, at least one of the second electrode elements 331A is aligned with one of the third air channels 3411A.

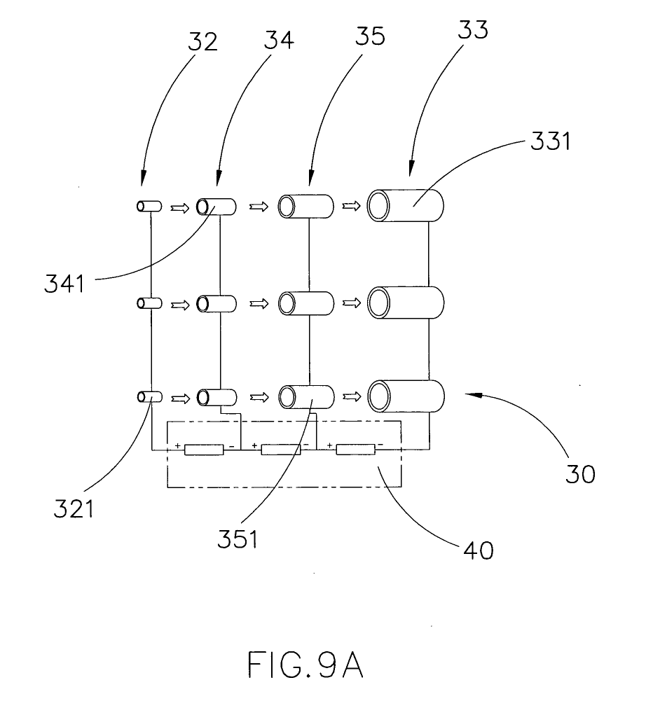

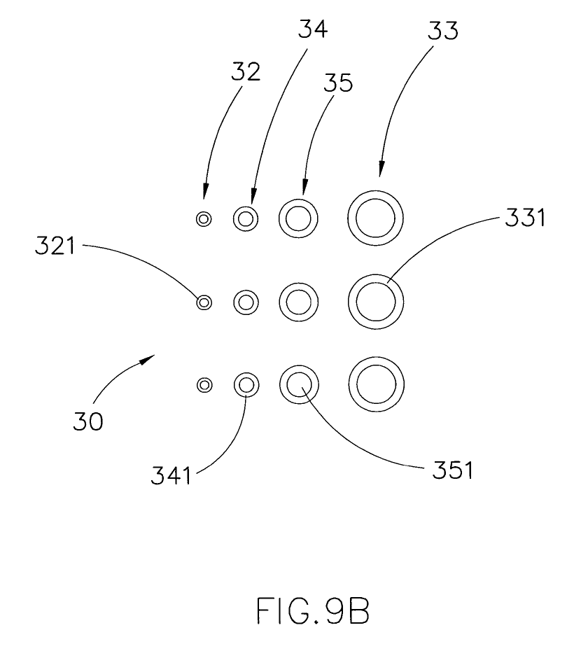

It is important to point out that the ionizing airflow generator 30 is capable of producing an airflow having a flow rate comparable to a conventional fan (1.0 m/s to 6.0 m/s) so that the present invention may be utilized in wide range of applications involving use of fans. Moreover, it is worth mentioning that the ionizing airflow generator 30 may comprise more than three electrode sets (e.g. four electrode sets 32, 33, 34, 35) in order to produce faster flow rate of the air flowing between the air inlet 12 and the air outlet 13, wherein each of the electrode elements 321, 331, 341, 351 can be made circular in shape, as shown in FIG. 9A and FIG. 9B of the drawings.

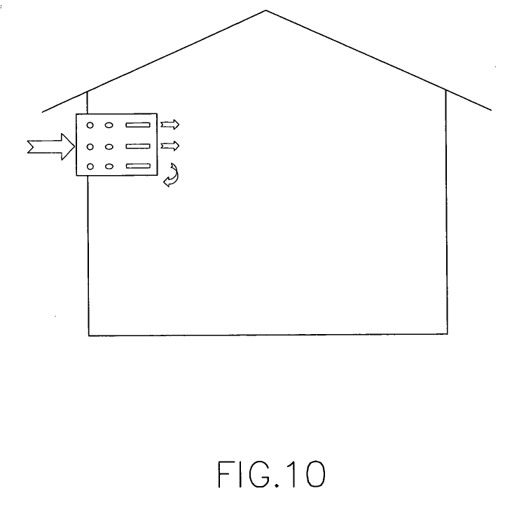

Referring to FIG. 10 of the drawings, the air current generator may be utilized for ventilation in a domestic environment without producing annoying noise so as to maintain a comfortable domestic environment for users of the present invention.

It is worth mentioning that the air temperature control device 20 can alternatively be embodied as an air heating system for generating heated air within the air ventilating cavity 11, wherein the air heating system is similar to the above-mentioned air cooling device in structure, saves where the thermodynamics cycle of the refrigerant is reversed to that in the air cooling device.

From the forgoing descriptions, it can be shown that the above-mentioned objects have been substantially accomplished. The present invention provides the air current generator which comprises the ionizing airflow generator 30 adapted for producing airflow to deliver air to an exterior of the air current generator without using any fan blades.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An air current generator, comprising:
an outer casing having an air ventilating cavity, an air inlet and an air outlet communicating said air ventilating cavity with an exterior of said outer casing;
a power unit supported within said outer casing;
an air temperature control device electrically connect to said power unit for generating a temperature-controlled air within said air ventilating cavity of said outer casing;
an ionizing airflow generator, which is electrically connected to said power unit, comprising:
an ionizing airflow unit, which is electrically connected to said power unit, comprising a first electrode set as an electrode terminal disposed within said outer casing at a position close to said air inlet, and a second electrode set disposed within said outer casing at said air outlet, wherein a voltage of said second electrode set is higher than a voltage of said first electrode set to generate an electrostatic force for drawing a flow of air from said air inlet to said air outlet so as to guide said temperature-controlled air within said outer casing to said exterior of said outer casing through said air outlet.

2. The air current generator, as recited in claim 1, wherein said ionizing airflow unit further comprises a third electrode set disposed within said outer casing at a position between said first and said second electrode set, wherein a voltage supplied to said third electrode set is higher than a voltage supplied to said first electrode set and lower than a voltage supplied to said second electrode set, so as to create an electrostatic force for drawing an accelerated flow of air moving from said third electrode set to said second electrode set for discharging through said air outlet.

3. The air current generator, as recited in claim 2, wherein said first through third electrode sets are electrically arranged in such a manner that said third electrode set is negative with respect to said first electrode set, while said third electrode set is positive with respect to said second electrode set.

4. The air current generator, as recited in claim 2, wherein said first electrode set comprises a plurality of first electrode elements spacedly formed in an array to define a first air channel between each two first electrode elements, wherein said second electrode set comprises a plurality of second electrode elements spacedly formed in an array to define a second air channel between each the two second electrode elements, and wherein said third electrode set comprises a plurality of third electrode elements spacedly formed in an array to define a third air channel between each said two third electrode elements, said air is accelerated to pass through said first through third air channels for delivering said temperature-controlled air out of said outer casing via said air outlet.

5. The air current generator, as recited in claim 3, wherein said first electrode set comprises a plurality of first electrode elements spacedly formed in an array to define a first air channel between each two first electrode elements, wherein said second electrode set comprises a plurality of second electrode elements spacedly formed in an array to define a second air channel between each the two second electrode elements, and wherein said third electrode set comprises a plurality of third electrode elements spacedly formed in an array to define a third air channel between each said two third electrode elements, said air is accelerated to pass through said first through third air channels for delivering said temperature-controlled air out of said outer casing via said air outlet.

6. The air current generator, as recited in claim 4, wherein each of said first electrode elements is an electrode wire supported within said air ventilating cavity at said air inlet, wherein each of said second electrode elements is an electrode blade supported within said air ventilating cavity at said air outlet, wherein each of said third electrode elements is an electrode shaft, having an electrode surface smaller than an electrode surface of said electrode blade, supported within said air ventilating cavity at a position between said electrode wire and said second electrode blade.

7. The air current generator, as recited in claim 5, wherein each of said first electrode elements is an electrode wire supported within said air ventilating cavity at said air inlet, wherein each of said second electrode elements is an electrode blade supported within said air ventilating cavity at said air outlet, wherein each of said third electrode elements is an electrode shaft, having an electrode surface smaller than an electrode surface of said electrode blade, supported within said air ventilating cavity at a position between said electrode wire and said second electrode blade.

8. The air current generator, as recited in claim 6, wherein said potential difference which is supplied by said power unit is in a range of five kilovolts to seventy kilovolts, and having a frequency in a range of eighteen kilohertz to one hundred and twenty kilohertz, wherein said power unit is arranged to supply a voltage of five kilovolts to thirty kilovolts to said first electrode set, a voltage of five kilovolts to forty kilovolts to said second electrode set, and a voltage of ten kilovolts to thirty kilovolts to said third electrode set.

9. The air current generator, as recited in claim 7, wherein said potential difference which is supplied by said power unit is in a range of five kilovolts to seventy kilovolts, and having a frequency in a range of eighteen kilohertz to one hundred and twenty kilohertz, wherein said power unit is arranged to supply a voltage of five kilovolts to thirty kilovolts to said first electrode set, a voltage of five kilovolts to forty kilovolts to said second electrode set, and a voltage of ten kilovolts to thirty kilovolts to said third electrode set.

10. The air current generator, as recited in claim 9, wherein at least one of said third electrode elements is aligned with one of said first air channels.

11. The air current generator, as recited in claim 9, wherein each of said first air channels is well aligned with said corresponding second air channels and said corresponding third air channels to allow air passing through said first through third air channels effectively.

12. The air current generator, as recited in claim 4, wherein each of said first electrode elements is an electrode shaft supported within said air ventilating cavity at said air inlet, wherein each of said second electrode elements is a second electrode blade supported within said air ventilating cavity at said air outlet, wherein each of said third electrode elements is a third electrode blade, having an electrode surface smaller than an electrode surface of said second electrode blade, supported within said air ventilating cavity at a position between said electrode shaft and said second electrode blade.

13. The air current generator, as recited in claim 5, wherein each of said first electrode elements is an electrode shaft supported within said air ventilating cavity at said air inlet, wherein each of said second electrode elements is a second electrode blade supported within said air ventilating cavity at said air outlet, wherein each of said third electrode elements is a third electrode blade, having an electrode surface smaller than an electrode surface of said second electrode blade, supported within said air ventilating cavity at a position between said electrode shaft and said second electrode blade.

14. The air current generator, as recited in claim 12, wherein said potential difference which is supplied by said power unit is in a range of five kilovolts to seventy kilovolts, and having a frequency in a range of eighteen kilohertz to one hundred and twenty kilohertz, wherein said power unit is arranged to supply a voltage of five kilovolts to thirty kilovolts to said first electrode set, a voltage of five kilovolts to forty kilovolts to said second electrode set, and a voltage of ten kilovolts to thirty kilovolts to said third electrode set.

15. The air current generator, as recited in claim 13, wherein said potential difference which is supplied by said power unit is in a range of five kilovolts to seventy kilovolts, and having a frequency in a range of eighteen kilohertz to one hundred and twenty kilohertz, wherein said power unit is arranged to supply a voltage of five kilovolts to thirty kilovolts to said first electrode set, a voltage of five kilovolts to forty kilovolts to said second electrode set, and a voltage of ten kilovolts to thirty kilovolts to said third electrode set.

16. The air current generator, as recited in claim 15, wherein at least one of said third electrode elements is aligned with one of said first air channels.

17. The air current generator, as recited in claim 15, wherein each of said first air channels is well aligned with said corresponding second air channels and said corresponding third air channels to allow air passing through said first through third air channels effectively.

18. The air current generator, as recited in claim 4, wherein each of said first electrode elements is an electrode wire supported within said air ventilating cavity at said air inlet, wherein each of said second electrode elements is a second electrode blade supported within said air ventilating cavity at said air outlet, wherein each of said third electrode elements is a third electrode blade, having an electrode surface larger than an electrode surface of said second electrode blade, supported within said air ventilating cavity at a position between said electrode shaft and said second electrode blade.

19. The air current generator, as recited in claim 5, wherein each of said first electrode elements is an electrode wire supported within said air ventilating cavity at said air inlet, wherein each of said second electrode elements is a second electrode blade supported within said air ventilating cavity at said air outlet, wherein each of said third electrode elements is a third electrode blade, having an electrode surface larger than an electrode surface of said second electrode blade, supported within said air ventilating cavity at a position between said electrode shaft and said second electrode blade.

20. The air current generator, as recited in claim 18, wherein said potential difference which is supplied by said power unit is in a range of five kilovolts to seventy kilovolts, and having a frequency in a range of eighteen kilohertz to one hundred and twenty kilohertz, wherein said power unit is arranged to supply a voltage of five kilovolts to thirty kilovolts to said first electrode set, a voltage of five kilovolts to forty kilovolts to said second electrode set, and a voltage of ten kilovolts to thirty kilovolts to said third electrode set.

21. The air current generator, as recited in claim 19, wherein said potential difference which is supplied by said power unit is in a range of five kilovolts to seventy kilovolts, and having a frequency in a range of eighteen kilohertz to one hundred and twenty kilohertz, wherein said power unit is arranged to supply a voltage of five kilovolts to thirty kilovolts to said first electrode set, a voltage of five kilovolts to forty kilovolts to said second electrode set, and a voltage of ten kilovolts to thirty kilovolts to said third electrode set.

22. The air current generator, as recited in claim 19, wherein at least one of said third electrode elements is aligned with one of said first air channels.

23. The air current generator, as recited in claim 19, wherein each of said first air channels is well aligned with said corresponding second air channels and said corresponding third air channels to allow air passing through said first through third air channels effectively.
